(19) United States
(12) Patent Application Publication
(10) Pub. No.: US 2026/0109518 A1
(43) Pub. Date: Apr. 23, 2026

(54) MEASURING AND DISPENSING DEVICE

(71) Applicants: Assaf Broitman, Princeville, HI (US); William Ryczek, Pomona, CA (US); Thomas Wai-Yan Wang, Pasadena, CA (US)

(72) Inventors: Assaf Broitman, Princeville, HI (US); William Ryczek, Pomona, CA (US); Thomas Wai-Yan Wang, Pasadena, CA (US)

(21) Appl. No.: 19/338,990

(22) Filed: Sep. 24, 2025

Related U.S. Application Data
(60) Provisional application No. 63/708,865, filed on Oct. 18, 2024.

(51) Int. Cl. B65D 47/12; A47G 19/24; B65D 47/28; B65D 81/26; G01F 11/18; G01F 11/26

(52) U.S. Cl. CPC B65D 47/123; A47G 19/24; B65D 47/283; B65D 81/264; G01F 11/18; G01F 11/261

(57) ABSTRACT

A measuring and dispensing device for a flowable material has a cap body configured to be removably secured to a container, the cap body having a bottom wall that extends across the container and has a bottom aperture configured to allow the flowable material to pass from the container into the cap body. A top housing extends over the bottom aperture, the top housing including a top wall having a top aperture. A metering button is slidably mounted within the top housing for rectilinear movement between a closed position and a dispensing position. A metering bore is formed through the metering button, the metering bore being aligned with the bottom aperture in the closed position to receive a predetermined volume of the flowable material, and being aligned with the top aperture in the dispensing position to dispense the predetermined volume of the flowable material. A biasing mechanism is disposed within the cap body for biasing the metering button toward the closed position.

### CROSS-REFERENCE TO RELATED APPLICATIONS

This application for a utility patent claims the benefit of U.S. Provisional Application No. 63/708,865, filed Oct. 18, 2024.

### BACKGROUND OF THE INVENTION

### Field of the Invention

This invention relates generally to flowable material dispensing devices, and more particularly to a flowable material dispensing device, such as a cap, that dispenses measured amounts of a flowable material such as powders, granules, spices, liquids, and similar materials.

### Description of Related Art

Conventional containers of flowable materials, such as containers of spices, powders, grains, and similar flowable material, include a cap or lid that has a variety of openings to allow free-pour or sprinkle dispensing. While these containers are functional for dispensing, they lack a mechanism for providing dispensing in a measured quantity, to provide an accurate, repeatable dispensing of the flowable material. As a result, users are required to use additional measuring tools such as measuring spoons or cups, creating inconvenience and inefficiency during cooking or other applications. For example, Robbins, U.S. Pat. No. 8,684,237, teaches a dispenser for dispensing measured amounts of a flowable material. The container includes a dispensing lever which, when pulled, dispenses a predetermined amount of the flowable material.

Furthermore, many flowable material, are susceptible to degradation when exposed to ambient moisture. Traditional storage and dispensing caps do not address this issue, often leading to clumping, reduced freshness, and shortened shelf life of the stored product. While desiccant packs are sometimes placed loosely within a container, this approach is impractical, inconsistent, and can create contamination risks.

Accordingly, there remains a need in the art for a dispensing device that not only enables dispensing a controlled and precise measurement of flowable materials directly from the container, but also incorporates features for preserving product freshness through integrated moisture control. The present invention satisfies these needs by providing a measuring and dispensing cap body that can be removably secured to standard containers, and which includes one or more metering mechanisms for dispensing predetermined volumes, as well as a desiccant housing for maintaining dryness of the stored material.

### SUMMARY OF THE INVENTION

The present invention teaches certain benefits in construction and use which give rise to the objectives described below.

The present invention provides a measuring and dispensing device for a flowable material. The device comprises a cap body configured to be removably secured to a container, the cap body having a bottom wall that extends across the container and has a bottom aperture configured to allow the flowable material to pass from the container into the cap body. A top housing extends over the bottom aperture, the top housing including a top wall having a top aperture. A metering button is slidably mounted within the top housing for rectilinear movement between a closed position and a dispensing position. A metering bore is formed through the metering button, the metering bore being aligned with the bottom aperture in the closed position to receive a predetermined volume of the flowable material, and being aligned with the top aperture in the dispensing position to dispense the predetermined volume of the flowable material. A biasing mechanism is disposed within the cap body for biasing the metering button toward the closed position.

A primary objective of the present invention is to provide a measuring and dispensing device having advantages not taught by the prior art.

Another objective is to provide a measuring and dispensing device that allows a user to dispense an accurately measured predetermined volume of a flowable material directly within the device prior to dispensing.

A further objective is to provide a measuring and dispensing device that incorporates a desiccant housing to remove moisture from the stored material and prolong freshness.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a perspective view of a measuring and dispensing device according to one embodiment of the present invention;

FIG. 2 is a sectional view of a cap body of the device taken along line 2-2 in FIG. 1;

FIG. 3 is a bottom perspective view of the cap body, illustrating a desiccant housing;

FIG. 4 is an exploded perspective view of a second embodiment of the cap body;

FIG. 5 is a sectional view of the second embodiment of the cap body, shown in a closed position;

FIG. 6 is a sectional view thereof, shown in a dispensing position;

FIG. 7 is a bottom perspective view of a desiccant cap;

FIG. 8 is a sectional view thereof;

FIG. 9 is a perspective view of a third embodiment of the cap body; and

FIG. 10 is a sectional view taken along lines 10-10 in FIG. 9.

### DETAILED DESCRIPTION OF THE INVENTION

The above-described drawing figures illustrate the invention, a measuring and dispensing device for measuring flowable material within the device prior to dispensing it out of the device.

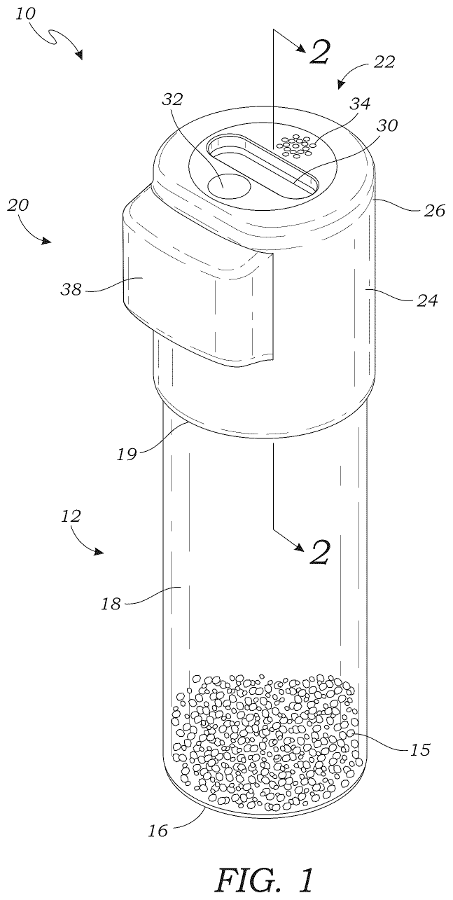

FIG. 1 is a perspective view of a measuring and dispensing device 10 according to one embodiment of the present invention. As shown in FIG. 1, the measuring and dispensing device 10 comprises a cap body 20 arranged to be removably secured to a container 12. The cap body 20 includes a dispensing mechanism 22 so that a flowable material 15 may be measured within the cap body 20 prior to being dispensed out of the cap body 20. The cap body 20 may further include a desiccant housing 60 that contains a desiccant for removing moisture from the flowable material 15, for prolonging freshness.

For the purposes of this application, the term “flowable material” is hereby defined to include any form of material capable of being dispensed out of the claimed device 10, including but not limited to spices, powders, grains, liquids, compounds, beads, pellets, etc., and/or any similar or equivalent materials. The term “desiccant” is defined to broadly include any hygroscopic substance that induces a state of desiccation (e.g., silica gel, or any other material known in the art for this purpose).

In various embodiments, the container 12 may be in the form of any standard container, typically having a base 16 with an upwardly extending sidewall 18 that extends upwardly to an upper perimeter 19 that engages the cap body 20. The container 12 may be a generally cylindrical container having a round cross-section, as shown in FIG. 1, but in other embodiments the container 12 may have other cross-sectional shapes, such as rectangular, oval, or any suitable shape desired by the manufacturer. The container 12 may be sized and adapted to fit in/on a spice rack, kitchen cabinet, table, etc., sized to fit in a single human hand. However, the inventive concept may apply to larger containers, provided the dispensing mechanism 22 functions as described in this application. Furthermore, the cap body 20 may be sized and adapted to fit onto existing containers, and/or may be mounted interchangeably on different containers, or be provided in a plurality of sizes and/or include various different attachment mechanisms to achieve this goal.

As shown in FIG. 1, the cap body 20 comprises a downwardly extending wall 24 that extends downwardly from a top housing 26. The top housing 26 includes a top wall 28 having a top aperture 30 through which the flowable material 15 is dispensed out of the device 10. In some embodiments, the top wall 28 may further include a rotatable mechanism 32 for closing, opening, or metering the top aperture 30 for dispensing. In the embodiment of FIG. 1, the rotatable mechanism 32 includes a perforated portion 34, i.e., for “sprinkling” the flowable material 15. The “open” position may allow for free and rapid pour of the material 15. Since this type of mechanism is well-known in the art, it is not described in further detail herein.

As shown in FIG. 1, a metering button 38 is slidably mounted within the top housing 26 for rectilinear movement between a closed position and a dispensing position. FIG. 1 shows the metering button 38 in the closed position, wherein pushing the metering button 38 inwardly would move it to the dispensing position. As used herein, “rectilinear movement” means movement along a substantially straight line between two positions. In some embodiments, the rectilinear movement is without substantial rotation, pivoting, or arcuate travel.

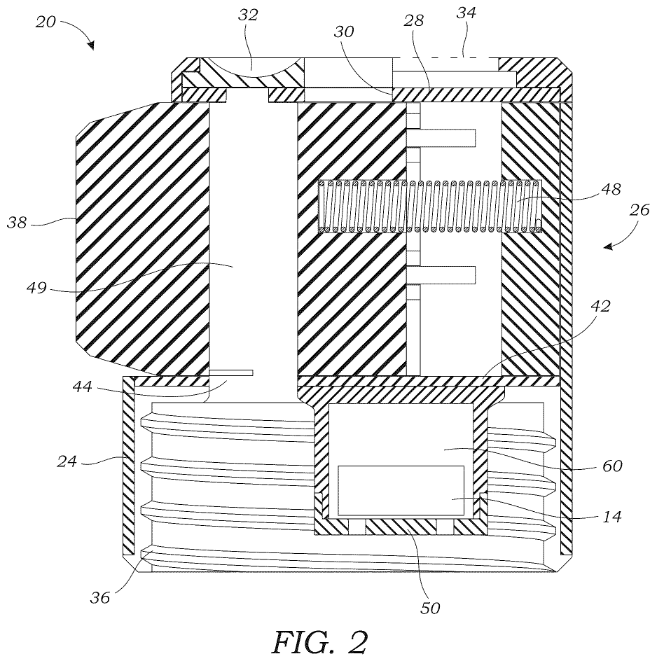

FIG. 2 is a sectional view of the cap body 20 of the device 10 taken along line 2-2 in FIG. 1. As shown in FIG. 2, the downwardly extending wall 24 has a means 36 for engaging with the container 12. In this embodiment, the means 36 is in the form of an internal thread for attachment to an externally threaded container 12, but any form of connection known in the art may be used.

As shown in FIGS. 1-2, a bottom wall of the cap body 20 extends across the container 12 to close the container 12, except for a bottom aperture 44 through the bottom wall 42 for allowing the flowable material 15 to flow out of the container 12 and into the cap body 20 when the container 12 is in an inverted position. Also shown in FIG. 2 is how the top housing 26 extends over the bottom aperture 44 of the bottom wall 42 of the cap body 20, the top housing 26 forming a receiving structure 46 that is covered by the top wall 28. As illustrated, the metering button 38 is slidably mounted within the top housing 26, between the top wall 28 and bottom wall 42, for rectilinear movement between the closed position and the dispensing position.

For purposes of this application, rectilinear movement is defined as a linear sliding movement, as opposed to rotational movement.

In various embodiments, a biasing mechanism 48 is included within the cap body 20 for biasing the metering button 38 towards the closed position. In this embodiment, the biasing mechanism 48 is in the form of a spring, wherein the spring 48 may be compressed by the metering button 38, so that a metering bore 49 is aligned with the top aperture 30 of the top wall 28.

The metering bore 49 has a predetermined volume (e.g., a teaspoon, or similar predetermined amount), wherein when the metering bore 49 is in the closed position, the flowable material 15 from the container 12 passes through the bottom aperture 44 and fills the metering bore 49 with the predetermined volume of the flowable material 15. When the metering button 38 is depressed to the dispensing position, the metering bore 49 is positioned to communicate with the top aperture 30, so that the predetermined volume of the flowable material 15 is dispensed through the top aperture 30.

As used herein, “predetermined volume” refers to a quantity of flowable material established in advance, whether factory-fixed, user-selected, or otherwise set before dispensing. The term encompasses both standardized measurements (e.g., teaspoon, tablespoon, milliliter) and custom volumes defined by the manufacturer or user.

As described above, the rotatable mechanism 32 also allows for free, open pour of material 15. Alternatively, the flowable material 15 may be dispensed through the perforated portion 34 without compressing the metering button 38.

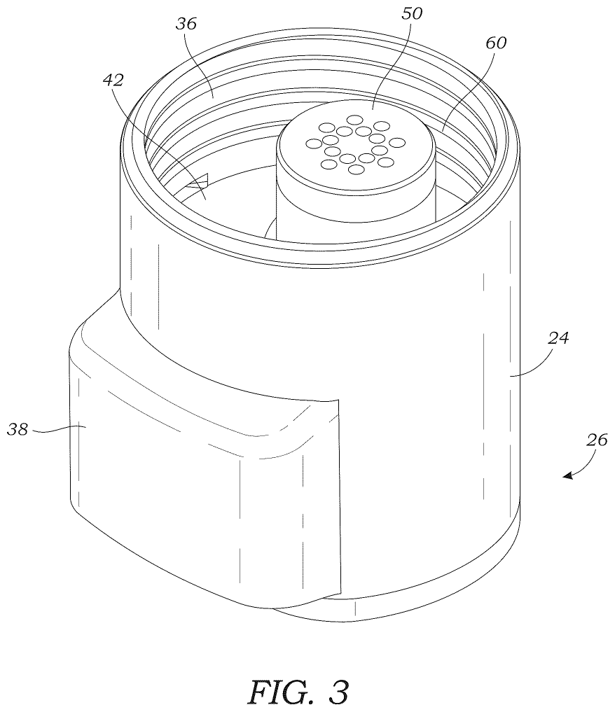

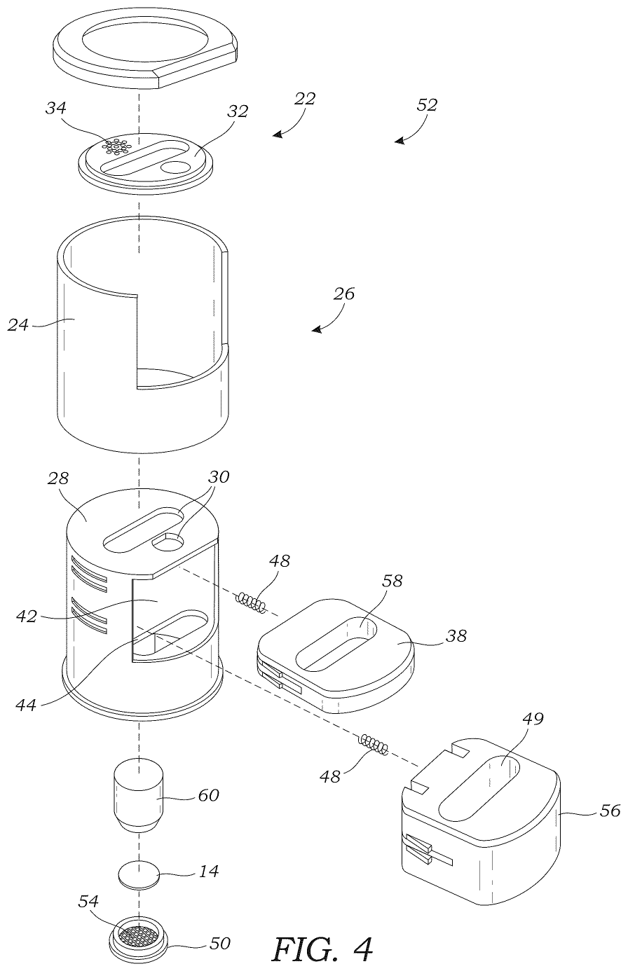

FIG. 3 is a bottom perspective view of the cap body 20, illustrating the desiccant housing 60. As shown in FIGS. 2-3, the desiccant housing 60 may extend from the bottom wall 42, within the downwardly extending wall 24, adjacent to and leaving room for the bottom aperture 44. The desiccant housing 60 may include a removable cover 50 for replacing desiccant 14 within the housing 60, or alternatively the cover may be fixed. Further components of the cover 50 are shown in FIG. 4 and discussed below.

FIG. 4 is an exploded perspective view of a second embodiment of the cap body 52. As shown in FIG. 4, in some embodiments, the cover 50 of the desiccant housing 60 may include a screen 54 within the housing 60, behind the cover 50, wherein the cover 50 is perforated to allow at least some airflow, but wherein the screen 54 prevents the actual desiccant 14 from falling out into the flowable material 15.

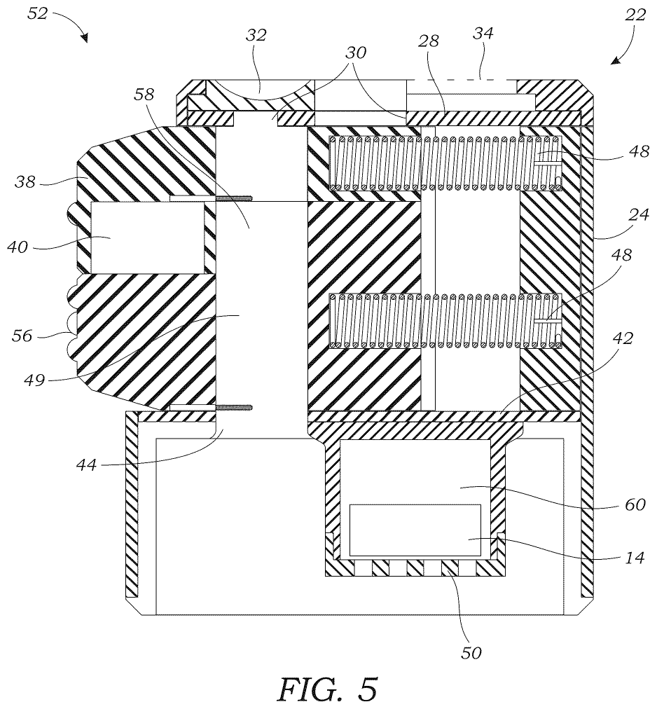

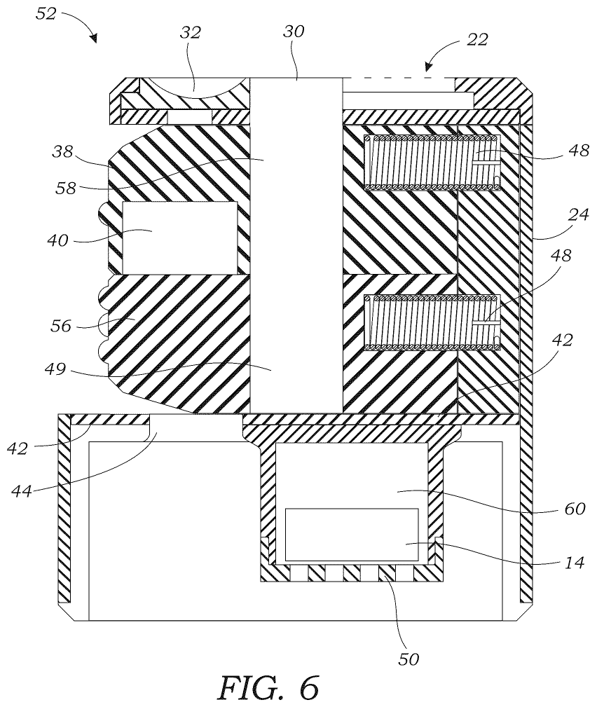

Also illustrated is a second metering button 56 slidably mounted within the top housing 26 between the metering button 38 and the bottom wall 42, so that the second metering button 56 is able to move in conjunction with the metering button 38, in the same rectilinear movement between a closed position and a dispensing position. In this embodiment, the biasing mechanism 48 is in the form of a pair of springs, wherein each metering button 38, 56 is biased by one of the springs 48 toward the closed position. In alternative embodiments, the biasing mechanism may be, for example, elastomeric bands, leaf springs, torsion members, and other equivalent mechanisms. Further details of the second embodiment of the cap body 20 are shown in FIGS. 5-6 and discussed below.

FIG. 5 is a sectional view of the second embodiment of the cap body 52, shown in a closed position, and FIG. 6 is a sectional view thereof, shown in the dispensing position. As shown in FIGS. 5-6, the second metering button 56 includes a second metering bore 58 therethrough, the second metering bore 58 having a second predetermined volume (e.g., a tablespoon), wherein when the second metering bore 56 is in the closed position, the flowable material 15 from the container 12 passes through the bottom aperture 44 and fills the second metering bore 56 with the second predetermined volume, and also fills the metering bore 38 with the predetermined volume of the flowable material 15. In such an embodiment, when the second metering button 56 is depressed to the dispensing position, the metering bore 38 and the second metering bore 56 are both positioned to communicate with the top aperture 30, so that both the predetermined volume plus the second predetermined volumes of the flowable material 15 are dispensed through the top aperture 30. As illustrated, there may be multiple top apertures 30 for use with the rotatable mechanism, limited only to the desires of the manufacturer.

As shown in FIGS. 5-6, in some embodiments, the first metering button 38 of the second embodiment 52 may further include a fillable chamber 40. In such an embodiment, when the first metering button 38 is in the dispensing position, but the second metering button 56 is in the closed position, flowable material 15 may pass through the bottom aperture 44, the second metering bore 58, and into the fillable chamber 40. In some embodiments, the second metering button 56 is then compressed into the dispensing position, wherein the first metering button 38 is further compressed into a second dispensing position (not shown), so that the flowable material 15 falls into the second metering bore 58. The first metering button 38 may then be positioned in the first dispensing position for dispensing the flowable material 15 that was captured in the fillable chamber 40 through the first metering bore 49 and out of the top aperture 30. The fillable chamber 40 may be a predetermined volume, such as a half teaspoon, for precise measurements.

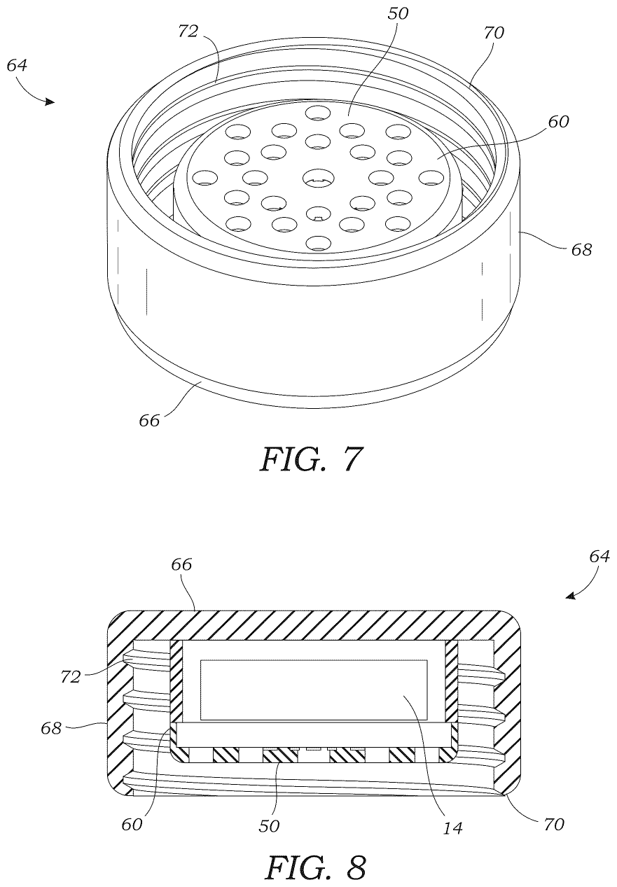

FIG. 7 is a bottom perspective view of a desiccant cap 64, and FIG. 8 is a sectional view thereof. As shown in FIGS. 7-8, in some embodiments, the container 12 is covered by the desiccant cap 64, instead of the cap body 20. In this embodiment, the desiccant cap 64 comprises a top wall 66 having a downwardly extending sidewall 68 that extends downwardly to a perimeter opening 70. The downwardly extending sidewall 68 may include a fastener 72, in this embodiment being in the form of a threaded inner surface. However, as discussed above, the fastener 72 may be any suitable form of fastener for attachment to the container 12, e.g., bayonet mounts, snap fits, magnetic couplers, etc.

As illustrated, the desiccant cap 64 further includes the desiccant housing 60 that extends downwardly from the top wall 66, within the sidewall 68. The desiccant cap 64 may be used when the user does not wish to dispense the flowable material 15 within the container 12, but instead wishes to store the container 12 with the desiccant 14 for maintained freshness.

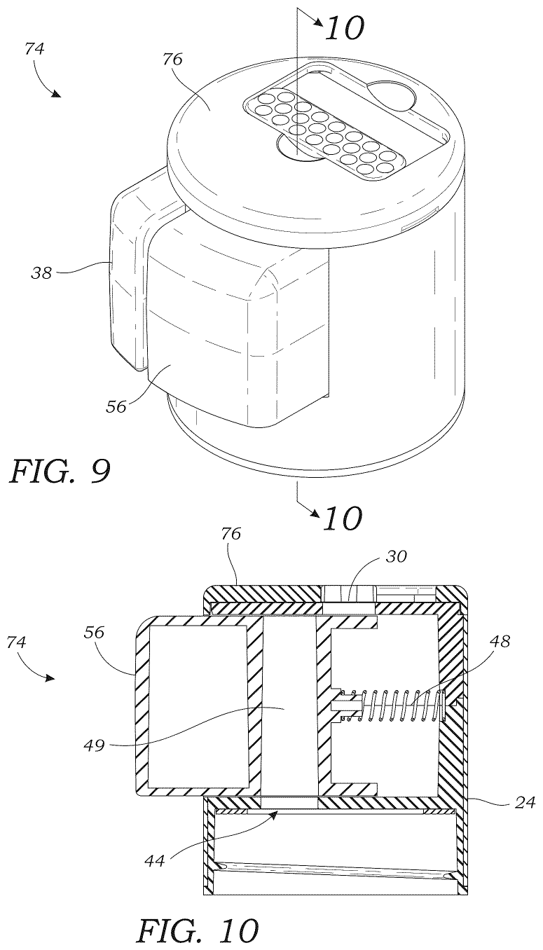

FIG. 9 is a perspective view of a third embodiment of the cap body 74, and FIG. 10 is a sectional view taken along lines 10-10 in FIG. 9. As shown in FIGS. 9-10, in this embodiment, the first and second metering buttons 38, 56 are positioned side-by-side instead of vertically stacked. The first metering button 38 may be wider than the second 56, which correlates with the size of the measurement volume, and also ensures the user can clearly differentiate between measurements. In this embodiment, the first metering button 38 measures out approximately 3/4 of a teaspoon, and the second metering button 56 measures out approximately 1/4 of a teaspoon. Therefore, when used together, the cap body 74 measures out one teaspoon.

As shown in FIGS. 9-10, an alternative cap 76 may be mounted on the top housing 26, which may provide more options for types of pour than the rotatable mechanism 32 of previous figures (perforations, different sizes of openings, etc.). In this embodiment, instead of rotating, the alternative cap 76 can move back and forth and be interchangeable to get different particle sizes.

In use, each metering button 38, 56 may be used separately or individually, to meter out one of three volumes of flowable material 15. The embodiment of FIGS. 9-10 offer a simplified version of the present invention, without the need for additional chambers or bores. However, in some embodiments, each metering button 38, 56 may include a fillable chamber (not shown), to increase the options for different volumes of flowable material 15 per measurement. While FIG. 10 does not show a desiccant, it may be included within this embodiment of the cap body.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A measuring and dispensing device for a flowable material, comprising:
a cap body configured to be removably secured to a container, the cap body having a bottom wall that extends across the container and has a bottom aperture configured to allow the flowable material to pass from the container into the cap body;
a top housing extending over the bottom aperture, the top housing including a top wall having a top aperture;
a metering button slidably mounted within the top housing for rectilinear movement between a closed position and a dispensing position;
a metering bore aligned with the bottom aperture in the closed position to receive a predetermined volume of the flowable material, and being aligned with the top aperture in the dispensing position to dispense the predetermined volume of the flowable material; and
a biasing mechanism disposed within the cap body for biasing the metering button toward the closed position.

2. The device of claim 1, wherein the the metering bore is formed through the metering button.

3. The device of claim 1, further comprising a rotatable mechanism disposed in the top wall for selectively opening, closing, or metering the top aperture to allow sprinkling or free-pour dispensing of the flowable material.

4. The device of claim 1, further comprising an upper cap mounted on the top housing for selectively opening, closing, or metering the top aperture to allow sprinkling or free-pour dispensing of the flowable material.

5. The device of claim 1, wherein the biasing mechanism comprises a spring configured to compress upon movement of the metering button toward the dispensing position.

6. The device of claim 1, wherein the predetermined volume of the metering bore corresponds to a standardized measurement of a spice or ingredient.

7. The device of claim 1, further comprising a desiccant housing extending from the bottom wall of the cap body adjacent the bottom aperture, the desiccant housing being configured to contain a desiccant for removing moisture from the flowable material.

8. The device of claim 5, wherein the desiccant housing includes a removable cover for replacing the desiccant.

9. The device of claim 5, wherein the desiccant housing includes a perforated cover and a screen disposed therein to allow airflow while preventing passage of desiccant into the flowable material.

10. The device of claim 1, further comprising a second metering button slidably mounted within the top housing in rectilinear movement between a closed position and a dispensing position, the second metering button including a second metering bore of a second predetermined volume, such that both the metering bore and the second metering bore are alignable with the top aperture to dispense a separate or combined predetermined volume.

11. The device of claim 8, wherein the second metering button includes a fillable chamber configured to temporarily receive flowable material for subsequent transfer into the second metering bore.

12. The device of claim 1, further comprising a second metering button slidably mounted within the top housing in rectilinear movement between a closed position and a dispensing position.

13. The device of claim 1, wherein the cap body includes an internal thread configured to engage an external thread of the container.

14. The device of claim 1, wherein the container is cylindrical and sized to fit in a human hand for dispensing spices.

15. A desiccant cap for covering a container of flowable material, comprising:
a top wall having a downwardly extending sidewall with a fastener for attachment to the container; and
a desiccant housing extending from the top wall within the sidewall, the desiccant housing containing a desiccant for reducing moisture in the flowable material.
